(19) United States
(12) Patent Application Publication
(10) Pub. No.: US 2012/0290366 A1
(43) Pub. Date: Nov. 15, 2012

(54) OPTIMIZATION OF PURCHASE BENEFITS BY USE OF MULTIPLE FINANCIAL ACCOUNTS

(75) Inventor: Jarrad A. Giles, Raleigh, NC (US)

(73) Assignee: International Business Machines Corporation, Armonk, NY (US)

(21) Appl. No.: 13/104,236

(22) Filed: May 10, 2011

(51) Int. Cl. G06Q 30/00; G06Q 40/00

(52) U.S. Cl. 705/14.1; 705/39

(57) ABSTRACT

Systems and methods for optimization of purchase benefits by use of multiple financial accounts are disclosed. According to an aspect, a method includes determining a category among multiple categories for each purchase item of multiple purchase items. The method may include determining reward program benefits associated with financial accounts. Further, the method may include associating each purchase item with one of the financial accounts based on the category of the purchase item and the reward program benefits. A purchase item may be associated with the financial account that provides the greatest monetary benefit in exchange for purchase of the purchase item. The method may also include conducting a plurality of purchase transactions for purchasing the purchase items. Each purchase transaction may use a different one of the financial accounts to purchase the purchase item(s) associated with the financial account.

### BACKGROUND

1. Field of the Invention

The present invention relates to electronic transactions, and more specifically, to systems and methods for optimizing purchase benefits by use of multiple financial accounts.

2. Description of Related Art

Financial institutions and various other businesses often provide their customers with financial cards, such as credit cards, debit cards, ATM cards, and other financial data cards. Such financial cards may be associated with a reward program in which consumers are provided with incentives to utilize such cards. For example, credit card companies often provide reward programs that provide purchasers with rewards for purchases made using their credit cards. In some instances, rewards are only provided when purchases are made for certain items, such as groceries and automobile fuel. Example rewards for purchases may include purchase discounts, travel discounts, and “cash back” benefits.

Consumers often carry multiple financial cards that each provides a different reward program. Particularly, for example, one card may provide cash back incentives for purchases of food items, and another card may provide travel points for purchases of automobile fuel or cosmetics. In addition, the monetary benefit of the reward may be greater for purchases of some items as compared to others. In this scenario, it may be advantageous for a consumer to use one financial card rather than another for the purchase of certain items. For at least this reason, it is desired to provide systems and methods for assisting consumers having multiple financial cards to optimize purchase benefits.

### BRIEF SUMMARY

One or more embodiments of the present invention provide methods and systems for optimization of purchase benefits by use of multiple financial accounts. According to an aspect, a method includes determining a category among multiple categories for each purchase item of multiple purchase items. A category of a purchase item may be, for example, a grocery, a service, or the like. The method may include determining reward program benefits associated with financial accounts. A financial account may include, for example, a credit account or a debit account. Further, the method may include associating each purchase item with one of the financial accounts based on the category of the purchase item and the reward program benefits. A purchase item may be associated with the financial account that provides the greatest monetary benefit in exchange for purchase of the purchase item. The method may also include conducting a plurality of purchase transactions for purchasing the purchase items. Each purchase transaction may use a different one of the financial accounts to purchase the purchase item(s) associated with the financial account.

### BRIEF DESCRIPTION OF THE SEVERAL VIEWS OF THE DRAWINGS

FIG. 1 is a block diagram of a purchase transaction system according to embodiments of the present invention;

FIG. 2 is a flowchart of a method for optimizing purchase benefits by use of multiple financial accounts in accordance with embodiments of the present invention; and

FIG. 3 is a flowchart of a method for optimizing purchase benefits in a retail store environment according to embodiments of the present invention.

### DETAILED DESCRIPTION

Exemplary systems and methods for optimizing purchase benefits by use of multiple financial accounts in accordance with embodiments of the present invention are disclosed herein. Particularly, described herein is a purchase transaction system configured to assist a user with purchasing multiple items by use of multiple financial accounts. The financial accounts may each be associated with different rewards programs having a different benefit for the purchaser. The purchase transaction system may assist the user with optimizing purchase benefits provided by the financial accounts when purchasing one or more items. For example, at a point of sale (POS) terminal in a retail store, the system may assist a purchaser of multiple items to use multiple financial cards in a way such that the rewards benefits of the financial accounts are optimized.

As referred to herein, the term “rewards program” refers broadly to any financial program providing rewards in exchange for use of a financial account for a purchase transaction. Example rewards include, but are not limited to, bonus, credit or loyalty incentive including loyalty, award, bonus, incentive, travel points or credits or currencies or miles, travel miles, hotel miles, hotel points, reward nights, reward stays, rental car miles, bonus rentals, rental car points, promotional currencies, award currencies, loyalty currencies, or the like.

In accordance with embodiments of the present invention, a purchase transaction system may be configured to determine a category among multiple categories for each purchase item of multiple purchase items. For example, the system may determine whether each item to be purchased is a grocery, service, office-related item, automobile-related item, consumer item, corporate item, media item, electronic item, home improvement item, or the like. In an example, an item may be assigned to multiple categories. The system may also be configured to determine reward program benefits associated with multiple financial accounts. For example, the system may determine reward program benefits for each of a purchaser's financial accounts. Reward program benefits may include, but are not limited to, loyalty point information, travel credit information (e.g., flyer miles), discount information (e.g., coupons), gift information, cash back information, donation information, and the like. The system may then associate one or more of the purchase items with one of the financial accounts based on the category of the purchase item and the reward program benefits. For example, a purchase item may be associated with the financial account among the purchaser's financial accounts that provides the greatest monetary benefit in exchange for purchase of the purchase item. Next, the system may use the multiple financial accounts to conduct multiple purchase transactions for purchasing the purchase items. Each purchase transaction may use a different one of the financial accounts to purchase one or more items associated with the financial account. By separating item purchases among the financial accounts in this manner, benefits of the reward programs may be optimized for purchasing the given purchase items.

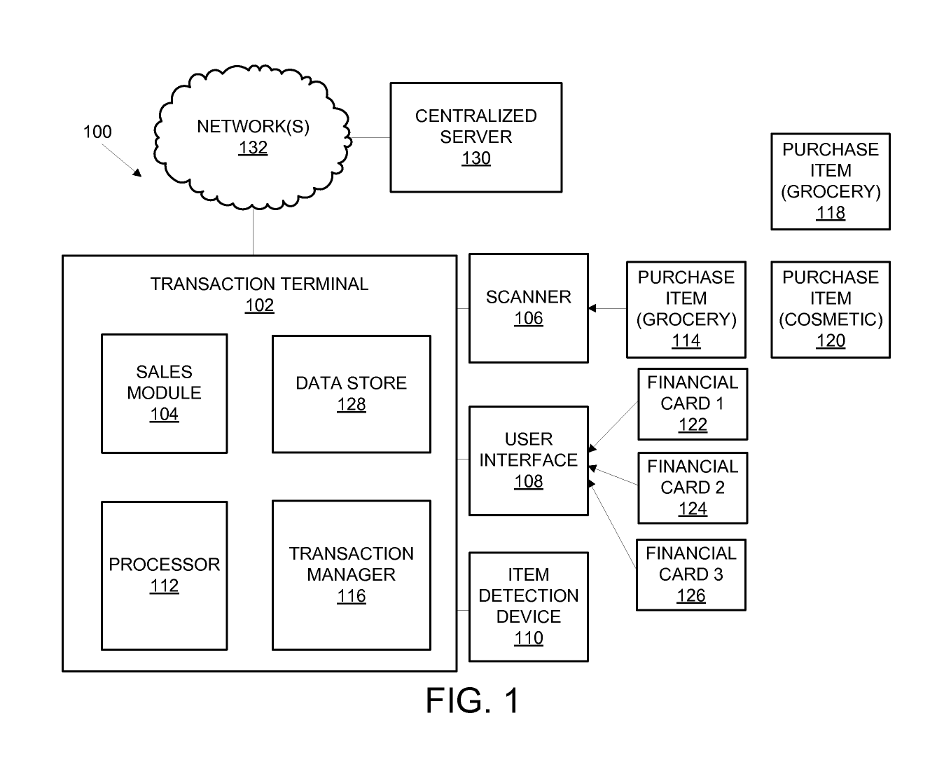

FIG. 1 illustrates a block diagram of a purchase transaction system 100 according to embodiments of the present invention. The purchase transaction system 100 may be implemented in whole or in part in any suitable purchase environment for conducting purchase transactions. For example, the system 100 may be implemented in a retail store such as in a self-checkout environment or in an online sales environment, such as in an Internet based sales environment. Referring to FIG. 1, the purchase transaction system 100 may include a transaction terminal 102 that may include a sales module 104, such as a POS application. The transaction terminal 102 may be communicatively coupled to a scanner 106, a user interface 108, and an item detection device 110. The sales module 104 may be an application that executes on a processor 112 of the transaction terminal 102. The transaction terminal 102 may include any suitable hardware, software, and/or firmware for implementing functions and processes in accordance with embodiments of the present invention. The purchase transaction system 100 may include any number of transaction terminals, and only one transaction terminal is shown in FIG. 1 for convenience of illustration.

The scanner 106 may be capable of reading a machine-readable image representing data from a purchase item 114. The scanner 106 may be a handheld device that can be passed over a barcode (e.g., a universal product code (UPC) or any other machine-readable image) on the purchase item 114 or may be built into a counter or platform whereby products are passed over the scanner. Further, the scanner 106 may read data from purchase items and transmit the data to the transaction terminal 102 via, for example, a wireless or wireline connection. In an example, the machine-readable image on the purchase item 114 may represent identification of the purchase item. Identification of the item may alternatively be provided to the transaction terminal by, for example, a user entering an identifier, such as a number, representing the item. The identification may be used for accessing data associated with the purchase item, such as, but not limited to, information for determining a category or pricing of the purchase item 114.

The user interface 108 may include a keyboard device that enables a shopper to input account and payment information for processing by the transaction terminal 102. For example, the user interface 108 may include a scanning device for reading a shopper's financial card (e.g., credit card or debit card) including account number. The keypad device may enable a shopper to enter a personal identification number (PIN) if using a debit card. The user interface 108 may include a display for displaying purchase and transaction information to the shopper. For example, the user interface 108 may be a touchscreen display for displaying text and graphics and for receiving user input. The user interface 108 may be communicatively coupled to the transaction terminal 102 via wireless or wireline elements.

The item detection device 110 may include a scale, sensor, or other instrument that captures information relating to purchase items. In an example, the item detection device 110 may detect the presence of a purchase item at a bagging area. Further, for example, the item detection device 110 may capture weight, dimension, color, and/or other measurements of purchase items. The transaction terminal 102 may use this information for identifying the item. The item detection device 110 may be communicatively coupled to the shopper terminal 110 via wireless or wireline elements (e.g., serial cable, 802.11 technologies, and the like).

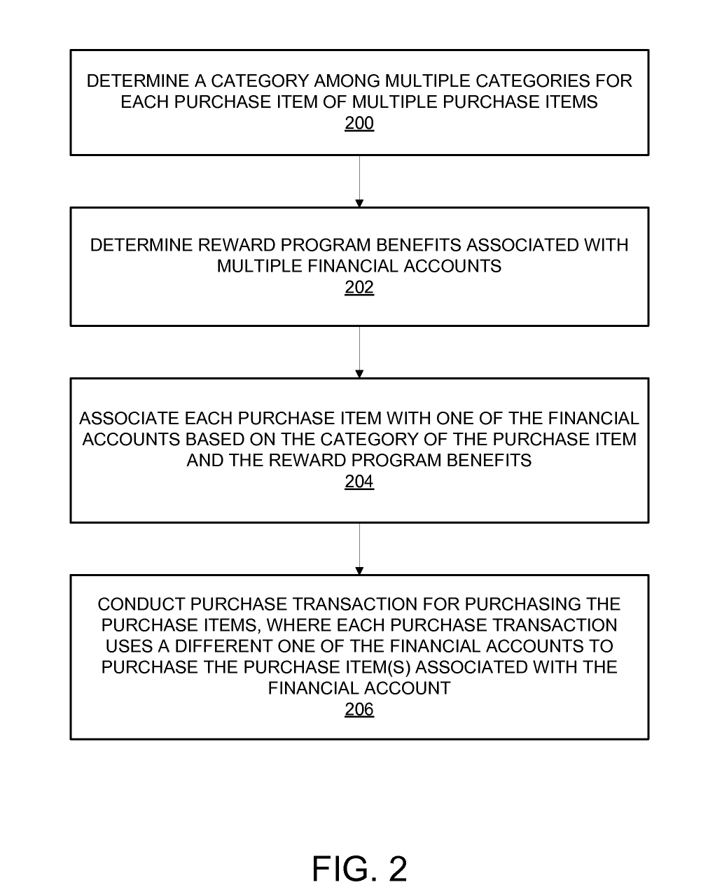

In accordance with embodiments of the present invention, the transaction terminal 102 may include a transaction manager 116 configured to determine purchase item categories, to determine reward program parameters associated with multiple financial accounts, and to associate each purchase item with one of the financial accounts. The sales module 104 may be configured to conduct multiple purchase transactions for purchasing purchase items for optimizing purchase benefits provided by the financial accounts. In an example, FIG. 2 illustrates a flowchart of a method for optimizing purchase benefits by use of multiple financial accounts in accordance with embodiments of the present invention. The method of FIG. 2 is described as being implemented by the purchase transaction system 100 shown in FIG. 1, although the method may be implemented by any suitable transaction system. The method may be implemented by hardware, software, and/or firmware of the purchase transaction system 100 and/or another computing device, such as a server.

Referring to FIG. 2, the method includes determining 200 a category among multiple categories for each purchase item of multiple purchase items. For example, the transaction manager 116 of the transaction terminal 102 shown in FIG. 1 may receive data associated with each item to be purchased by a purchaser. The transaction manager 116 may use the data to determine a category for each purchase item. In a more specific example, the data associated with a purchase item may be metadata associated with an identifier for the purchase item. The metadata may include information indicating the category of the purchase item. Example categories include, but are not limited to, a grocery, service, office-related item, automobile-related item, consumer item, corporate item, media item, electronic item, home improvement item, or the like.

The method of FIG. 2 includes determining 202 reward program benefits associated with multiple financial accounts. For example, the transaction manager 116 shown in FIG. 1 may receive identifications of a purchaser's financial accounts. In this example, the transaction manager 116 may use the identifications to retrieve the reward program benefits. In an example, information about the reward program benefits may be stored together with the identification, or may be stored at a server. The transaction manager 116 may use the financial account identifications for accessing information about reward program benefits. Example reward program benefits include, but are not limited to, loyalty point information, travel credit information (e.g., flyer miles), discount information (e.g., coupons), gift information, cash back information, donation information, the like, and combinations thereof.

The method of FIG. 2 includes associating 204 each purchase item with one of the financial accounts based on the category of the purchase item and the reward program benefits. For example, the transaction manager 116 may determine, for each purchase item, a monetary value that can be received by the purchaser in exchange for purchase of the item by use of each financial account. In this example, the transaction manager 116 may associate each purchase item with the financial account that provides the greatest monetary benefit to the purchaser in exchange for purchase of the item.

The method of FIG. 2 includes conducting 206 purchase transactions for purchasing the purchase items. Each purchase transaction uses a different one of the financial accounts to purchase the purchase item(s) associated with the financial account. For example, the sales module 104 may use, for purchase of each item, the financial account that has been determined to provide the greatest monetary benefit to the purchaser in exchange for purchase of the item. As a result, multiple financial accounts may be used in multiple different transactions for purchasing the items. Multiple different accounts can be used, because the financial accounts can provide different benefits for purchase of items. In this way, the benefits of the use of the financial accounts can be optimized for purchase of multiple items.

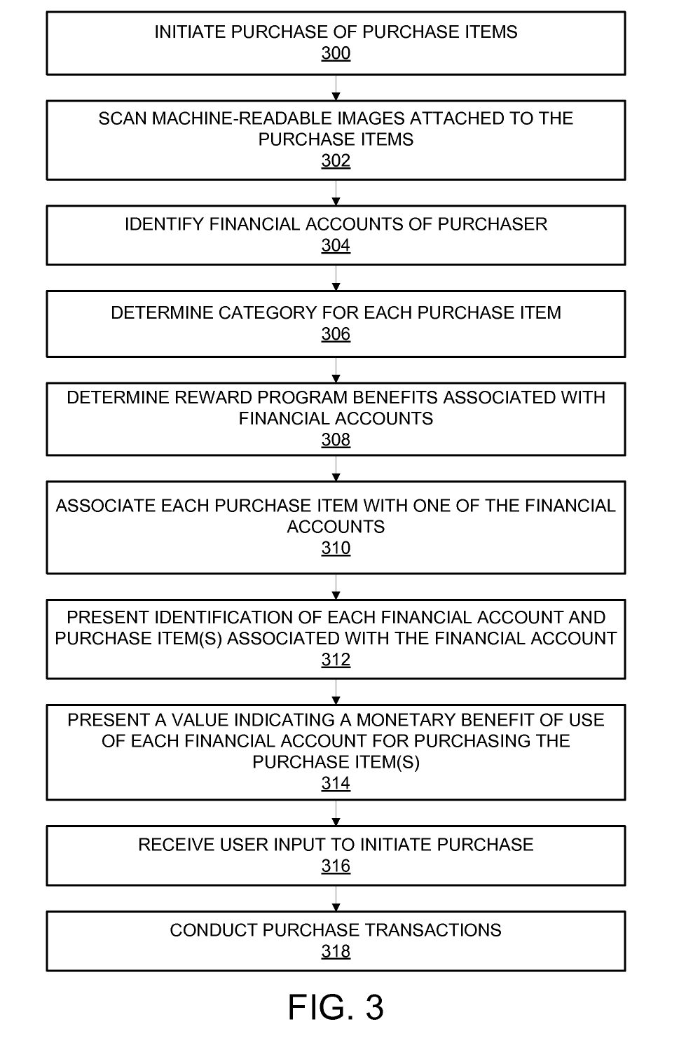

In an example, the purchase transaction system 100 of FIG. 1 may be used in a retail store environment. FIG. 3 illustrates a flowchart of a method for optimizing purchase benefits in a retail store environment according to embodiments of the present invention. The method of FIG. 3 is described as being implemented by the purchase transaction system 100 shown in FIG. 1, although the method may be implemented by any suitable transaction system. The method may be implemented by hardware, software, and/or firmware of the purchase transaction system 100 and/or another computing device, such as a server.

Referring to FIG. 3, the method includes the method includes initiating 300 a purchase of purchase items. For example, at a checkout terminal in a retail store, a cashier may input commands into a user interface of a transaction terminal for initiating checkout of a shopper. In an example of a self-checkout environment, the transaction terminal 102 shown in FIG. 1 may be a self-checkout terminal, and a purchaser may interact with the user interface 108 to enter input for initiating purchase of items 114, 118, and 120. In this example, the purchaser may select an icon displayed on a display of the user interface 108 to initiate purchase of the items 114, 118, and 120. In response to receiving the user input for initiating the purchase, the transaction manager 116 may initiate the transaction with the purchaser.

The method of FIG. 3 includes scanning 302 machine-readable images attached to the purchase items. For example, the scanner 106 may scan barcodes on packaging of each purchase item 114, 116, and 118. The barcode may represent UPC information or other identification of a purchase item. Alternatively, identification of a purchase item and/or other information (e.g., category information) about a purchase item may be received by use of a barcode reader, a radio frequency identification (RFID) chip reader, or other suitable scanning device to obtain data from the item.

The method of FIG. 3 includes identifying 304 financial accounts of the purchaser. For example, financial accounts of a purchaser may be identified by use of an input terminal configured to read data from a purchaser's financial cards. The financial cards may include a magnet stripe containing data that may be read by a suitably configured input device having a magnetic reading head. In the example of FIG. 1, the user interface 108 may include an input device configured to read magnet stripes on financial cards 122, 124, and 126. The data read from the financial cards 122, 124, and 126 may identify the financial accounts of the purchaser. Other data stored on a financial card may include an American Banking Association (ABA) banking identification number (BIN) which provides routing instructions for data through a banking network or other dedicated network. The financial card data may include data used for a purchase transaction request. The financial cards may include, but are not limited to, a credit card, debit card, ATM card, and other financial data card. The user interface 108 may communicate the read data to the transaction terminal 102. The transaction manager 116 may use the read data for identifying the financial accounts of the purchaser. For example, the transaction manager 116 may use the read data to search a database in a data store 128 for identification of a financial account. The data store 128 may also include other information about the financial account.

In accordance with embodiments of the present invention, the transaction manager 116 may use the read data to request identification of a financial account or other information about the financial account from a remote server. For example, the transaction terminal 102 may be communicatively coupled to a centralized server 130 via one or more networks 132. The transaction terminal 102 may be configured to communicate a request for financial account identification and/or other financial account information from the server 130. The request may include data read from one or more financial cards for use by the server 103 in retrieving the financial account identification or other information. The server 130 may be configured to provide financial account identification to the transaction terminal 102 in response to a request.

In embodiments of the present invention, data for identifying financial accounts of a purchaser may be read from a loyalty card, rewards card, points card, advantage card, and/or club card. Such cards may include a magnetic stripe containing data that may be read by the user interface 108. The read data may include user profile information that may be used to identify financial accounts of the purchaser. The read data may be communicated to the transaction manager 116. The data may identify the purchaser. The transaction manager 116 may use the purchaser identification for performing a lookup in the data store 128 for financial accounts associated with the purchaser. Alternatively, for example, the transaction manager 116 may use the purchaser identification for requesting financial account identification and/or other financial account information from the centralized server 130. Financial account information or other data for identifying a financial account may be read from a contactless payment instrument presented by the purchaser (e.g., RFID chip).

The method of FIG. 3 may include determining 306 a category associated with each purchase item. For example, the transaction manager 116 of the transaction terminal 102 may receive the UPC information scanned from each purchase item 114, 118, and 120. The transaction manager 116 may use the UPC information to determine a category for each purchase item 114, 118, and 120. In the example of FIG. 1, purchase items 114 and 118 are grocery items, and purchase item 120 is a cosmetic item.

The method of FIG. 3 includes determining 308 reward program benefits associated with the financial accounts. For example, the transaction manager 116 may use the financial account identifications for determining reward program benefits provided by the financial accounts. The data store 128 may store information about the reward program benefits. The transaction manager 116 may use a financial account identification for looking up the reward program benefits for the financial account in the data store 128. Alternatively, for example, the centralized server 130 or another server may store the reward program benefits, and the transaction manager 116 may look up the reward program benefits by use of the financial account identification. The reward program benefits may include a discount, credit, and the like that a program member is able to apply towards the transaction amount of an item being purchased. For example, a member who has accrued reward points through a reward program may be eligible to apply at least a portion of those points towards reducing the transaction amount at the point of sale for purchase of the item.

The method of FIG. 3 includes associating 310 each purchase item with one of the financial accounts. Each purchase item may be associated with one of the financial accounts based on a category of the purchase item and the reward program benefits for the purchaser. For example, the transaction manager 116 may determine, for each item, a monetary benefit provided by each financial account in exchange for purchase of the item using the financial account. In an example, the transaction manager 116 may determine a monetary benefit provided for the purchase of purchase item 114 by use of each financial account associated with financial cards 122, 124, and 126. The transaction manager 116 may make such a determination for each of the other items for purchase, i.e., purchase items 118 and 120. Further, the transaction manager 116 may compare the financial benefits provided by the financial accounts for determining, for each purchase item, the financial account that provides the greatest monetary benefit in exchange for purchase of the item. The transaction manager 116 may associate each purchase item with the financial account among the purchaser's financial accounts that provides the greatest monetary benefit in exchange for purchase of the purchase item. In an example, the transaction manager 116 may store information in the data store 128 for indicating the associations of the purchase items with respective financial accounts.

In an example of financial benefits, the financial account of financial card 122 may provide 1% cash back rewards in exchange for all purchases, and may provide 5% cash back for purchases of gas, home improvement items, and department store items. The financial account of financial card 124 may provide 10% discounts in exchange for purchases of cosmetics. The financial account of financial card 126 may provide 1.25% cash back rewards in exchange for all purchases. For grocery items such as items 114 and 118, purchase of the items by use of financial card 126 provides the greatest monetary benefit, because a 1.25% cash back reward is provided for the purchase, whereas only 1% cash back is provided by use of financial card 122, and no reward is provided for purchase of the item by financial card 124. For cosmetic items such as item 120, purchase of the item by use of financial card 124 provides the greatest monetary benefit, because a 10% discount reward is provided for the purchase, whereas only 1% cash back is provided by use of financial card 122, and 1.25% cash back is provided by use of financial card 126. The transaction manager 116 may determine the financial account providing the greatest monetary benefit for purchase of each item based on the reward percentages. The transaction manager 116 may associate each item with the financial account that provides the highest percentage award for purchase of item.

The method of FIG. 3 includes presenting 312 identification of each financial account and one or more purchase items associated with the financial account. Continuing the example of financial benefits provided by financial cards 122, 124, and 126, the transaction manager 116 may control a display of the user interface 108 to display a name of each financial account and the purchase item(s) associated with each financial account. The method of FIG. 3 includes presenting 314 a value indicating a monetary benefit of use of each financial account for purchasing the purchase items. For example, the transaction manager 116 may also control the display to display the reward percentages for use of the financial accounts to purchase the items. Table 1 below shows an example of financial card identifiers and monetary benefit values associated with the purchase items 114, 118, and 120.

TABLE 1
Financial Card Identifiers, Monetary Benefits,
and Associated Purchase Items

| Financial Account | | Monetary Benefit |
|---|---|---|
| Identifier | Purchase Item | (Percentage) |
| FC3 (Financial Card 126) | Bread (Purchase Item 114) | 1.25% |
| FC3 (Financial Card 126) | Milk (Purchase Item 118) | 1.25% |
| FC2 (Financial Card 124) | Lipstick | 10% |
| | (Purchase Item 120) | |

The information shown in Table 1 may be displayed to a purchaser in any suitable format. In addition or alternative to the percentage benefit, the transaction manager 116 may determine a monetary value benefit (e.g., dollar amount) for the purchaser by purchase of the item by use of the financial account. In this way, the purchaser may be provided at checkout, such as at a point-of-sale terminal, with detailed information about benefits that may be received by use of financial cards for each of the items to be purchased. By presentation of this information, the purchaser may make an informed decision about the use of his or her financial cards for purchase of the items.

The method of FIG. 3 includes receiving 316 user input to initiate the purchase. For example, a purchaser of items 114, 118, and 120 may enter input using the user interface 108 for initiating purchase of the items. In an example, the user may touch a button or area of a touch screen display for initiating the purchase of items using the associated financial accounts according to Table 1. Alternatively, the user may enter input for selecting a different financial account for purchasing one or more of the items. For example, the user may enter input to select the financial account of financial card 122 for use in purchasing items 114 and 118 rather than the financial account of financial card 126 as shown in Table 1.

The method of FIG. 3 may include conducting 318 purchase transactions for purchasing the purchase items. For example, the sales module 104 may conduct purchase transactions where each purchase transaction uses a different one of the financial accounts to purchase the one or more purchase items associated with the financial account. Continuing the above example of Table 1, the sales module 104 may conduct a transaction for purchasing purchase items 114 and 118 by use of financial card 126, and may conduct a transaction for purchasing item 120 by use of the financial card 124. The transaction manager 116 may implement purchase transactions in response to receiving user input for initiating the purchases.

In an example, the sales module 104 may implement the multiple purchase transactions by transmitting financial card account transaction information over a network to multiple different financial companies that process the purchase transactions and authorize or decline the transactions. Transactions may also be performed over the Internet by manually entering numbers of the financial accounts and purchaser information. The numbers and purchaser information may be communicated to the financial companies for authorization or decline of the transactions.

In accordance with embodiments of the present invention, the sales module 104 may purchase the items using user-selected financial accounts. For example, the user may enter input for selecting a different financial account than one of the accounts identified in Table 1 for purchasing one or more of the items. In this example, the sales module 104 may use the user-selected financial account and another financial account identified in Table 1 for purchasing the items.

In accordance with embodiments of the present invention, financial accounts may be associated with a user's loyalty profile. Further, the reward benefits for use of each financial account may be associated with the loyalty profile. In an example, the data store 128 of the transaction terminal 102 or a remote server, such as the server 130, may store a user's loyalty profile information including financial account information and reward benefit information for each financial account. In response to identifying a user at the transaction terminal 102, the transaction manager 116 may access the user's financial account information and reward benefit information from the data store 128 or the remote server. The reward benefit information for each of financial account of the user may be displayed or otherwise presented to the user such that the user may select which financial accounts to use when purchasing items.

In accordance with embodiments of the present invention, a transaction terminal may store information about multiple items and current reward information for financial accounts of a purchaser. Example item information includes, but is not limited to, pricing information and category information. The current reward information may be a current total of rewards for each financial account of the user. Such reward totals may be used for determining which of the financial accounts would provide the greatest monetary benefit for the purchase of one or more items to be purchased by the user in accordance with embodiments of the present invention. The item information and reward information may be stored, for example, in the data store 128 shown in FIG. 1.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter situation scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or diagrams of methods, apparatus (systems) and computer program products according to embodiments of the invention. For example, aspects of the present invention are described with reference to the diagram of FIG. 1 and the flowcharts of FIGS. 2 and 3. It will be understood that each block of the flowchart illustrations and/or diagrams, and combinations of blocks in the flowchart illustrations and/or diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
determining a category among a plurality of categories for each purchase item of a plurality of purchase items;
determining reward program benefits associated with a plurality of financial accounts;
associating each purchase item with one of the financial accounts based on the category of the purchase item and the reward program benefits; and
conducting a plurality of purchase transactions for purchasing the purchase items, wherein each purchase transaction uses a different one of the financial accounts to purchase the one or more purchase items associated with the financial account.

2. The method of claim 1, wherein determining a category for each purchase item comprises:
receiving data associated with the purchase item; and
using the data to determine the category for the purchase item.

3. The method of claim 2, comprising reading a machine-readable image on the purchase item that represents identification of the purchase item, and
wherein receiving data comprises using identification of the purchase item to access the data associated with the purchase item.

4. The method of claim 1, wherein determining a category for each purchase item comprises determining whether the category of each purchase item is one of a grocery, service, office-related item, automobile-related item, consumer item, corporate item, media item, electronic item, and home improvement item.

5. The method of claim 1, wherein the reward program benefits includes at least one of loyalty point information, travel credit information, discount information, gift information, cash back information, and donation information.

6. The method of claim 1, comprising receiving identifications of the financial accounts; and
wherein determining reward program benefits comprises using the identifications to retrieve the reward program benefits.

7. The method of claim 6, wherein receiving identifications of the financial accounts comprises receiving user profile information including the identifications.

8. The method of claim 6, wherein receiving identifications of the financial accounts comprises reading the identifications of the financial accounts from a plurality of financial cards.

9. The method of claim 1, wherein associating each purchase item with one of the financial accounts comprises associating each purchase item with the financial account among the financial accounts that provides the greatest monetary benefit in exchange for purchase of the purchase item.

10. The method of claim 1, comprising presenting, to a purchaser, identification of each financial account and the one or more purchase items associated with the financial account.

11. The method of claim 10, comprising receiving user input to initiate purchase of the one or more items by use of the associated financial accounts.

12. The method of claim 11, wherein conducting the plurality of purchase transactions is implemented in response to receiving the user input.

13. The method of claim 11, comprising presenting, to a purchaser, a value indicating a monetary benefit of the use of each financial account for purchasing the associated one or more purchase items.

14. A system comprising:
a transaction manager configured to:
determine a category among a plurality of categories for each purchase item of a plurality of purchase items;
determine reward program benefits associated with a plurality of financial accounts; and
associate each purchase item with one of the financial accounts based on the category of the purchase item and the reward program benefits; and
a sales module configured to conduct a plurality of purchase transactions for purchasing the purchase items, wherein each purchase transaction uses a different one of the financial accounts to purchase the one or more purchase items associated with the financial account.

15. The system of claim 1, wherein the transaction manager is configured to:
receive data associated with the purchase item; and
use the data to determine the category for the purchase item.

16. The system of claim 15, comprising a scanner configured to read a machine-readable image on the purchase item that represents identification of the purchase item, and
wherein the transaction manager is configured to use identification of the purchase item to access the data associated with the purchase item.

17. The system of claim 14, wherein the transaction manager is configured to determine whether the category of each purchase item is one of a grocery, service, office-related item, automobile-related item, consumer item, corporate item, media item, electronic item, and home improvement item.

18. The system of claim 14, wherein the reward program benefits includes at least one of loyalty point information, travel credit information, discount information, gift information, cash back information, and donation information.

19. The system of claim 14, wherein the transaction manager is configured to:
receive identifications of the financial accounts; and
use the identifications to retrieve the reward program benefits.

20. The system of claim 19, wherein the transaction manager is configured to receive user profile information including the identifications.

21. The system of claim 19, comprising a scanner configured to read the identifications of the financial accounts from a plurality of financial cards.

22. The system of claim 14, wherein the transaction manager is configured to associate each purchase item with the financial account among the financial accounts that provides the greatest monetary benefit in exchange for purchase of the purchase item.

23. The system of claim 14, comprising a user interface configured to present, to a purchaser, identification of each financial account and the one or more purchase items associated with the financial account.

24. The system of claim 14, comprising a user interface configured to receive user input to initiate purchase of the one or more items by use of the associated financial accounts.

25. A computer program product for optimizing purchase benefits, said computer program product comprising:
a computer readable storage medium having computer readable program code embodied therewith, the computer readable program code comprising:
computer readable program code configured to determine a category among a plurality of categories for each purchase item of a plurality of purchase items;
computer readable program code configured to determine reward program benefits associated with a plurality of financial accounts;
computer readable program code configured to associate each purchase item with one of the financial accounts based on the category of the purchase item and the reward program benefits; and
computer readable program code configured to conduct a plurality of purchase transactions for purchasing the purchase items, wherein each purchase transaction uses a different one of the financial accounts to purchase the one or more purchase items associated with the financial account.
